(19) United States
(12) Patent Application Publication
(10) Pub. No.: US 2017/0228164 A1
(43) Pub. Date: Aug. 10, 2017

(54) USER-LEVEL INSTRUCTION FOR MEMORY LOCALITY DETERMINATION

(71) Applicant: Advanced Micro Devices, Inc., Sunnyvale, CA (US)

(72) Inventors: Nuwan S. Jayasena, Sunnyvale, CA (US); Dong Ping Zhang, San Jose, CA (US); Kevin McGrath, Los Gatos, CA (US)

(21) Appl. No.: 15/040,848

(22) Filed: Feb. 10, 2016

(51) Int. Cl. G06F 3/06; G06F 12/10; G06F 12/08

(52) U.S. Cl. CPC G06F 3/067; G06F 3/0611; G06F 3/0653; G06F 12/0802; G06F 12/10; G06F 2212/60

(57) ABSTRACT

Systems and methods for efficiently processing data in a non-uniform memory access (NUMA) computing system are disclosed. A computing system includes multiple nodes connected in a NUMA configuration. Each node includes a processing unit which includes one or more processors. A processor in a processing unit executes an instruction that identifies an address corresponding to a data location. The processor determines whether a memory device stores data corresponding to the address. A response is returned to the processor. The response indicates whether the memory device stores data corresponding to the address. The processor completes processing of the instruction without retrieving the data.

This invention was made with Government support under Prime Contract Number DE-AC52-07NA27344, Subcontract No. B609201 awarded by the United States Department of Energy. The Government may have certain rights in this invention.

### BACKGROUND OF THE INVENTION

Technical Field

This invention relates to computing systems, and more particularly, to efficiently processing data in a non-uniform memory access (NUMA) computing system.

Description of the Relevant Art

Many techniques and tools are used, or are in development, for transforming raw data into meaningful information for analytical purposes. Such analysis may be performed for applications in the finance, medical, entertainment and other fields. In addition, advances in computing systems have helped improve the efficiency of the processing of large volumes of data. Such advances include advances in processor microarchitecture, hardware circuit fabrication techniques and circuit design, application software development, compiler development, operating systems, and so on. However, obstacles still exist to the efficient processing of data.

One obstacle to efficient processing of data is the latency of accesses by a processor to data stored in a memory. Generally speaking, application program instructions and corresponding data items are stored in memory. Because the processor is separate from the memory and data must be transferred between the two, access latencies and bandwidth bottlenecks exist. Some approaches to reducing the latency include the use of a cache memory subsystem, prefetching program instructions and data items, and managing multiple memory access requests simultaneously with multithreading.

Although the throughput of processors has dramatically increased, advances in memory design have largely been directed to increasing storage densities. Therefore, even though a memory may be able to store more data in less physical space, the processor may still consume an appreciable amount of time idling while waiting for instructions and data items to be transferred from the memory to the processor. This problem may be made worse when program instructions and data items are transferred between two or more off-chip memories and the processor.

Approaches to performance improvements for particular workloads include high memory capacity non-uniform memory access (NUMA) systems. In such systems, a given processor of multiple processors is associated with certain tasks and the memory access time depends on whether requested data items are located in local memory or remote memory. In these systems, higher performance is obtained when the data items are locally stored. However, if the data items are not local to the processor, then longer data transfer latencies, lower bandwidths, and/or higher energy consumption may be incurred.

In addition to the above, data may move (“migrate”) from one location to another. For example, the operating system (OS) may perform load balancing and move threads and corresponding data items from one processor or node to another. Further, the OS may remove mappings for pages and move the pages to disk, advanced memory management systems may perform page migrations, copy-on-write operations may be executed, and so on. In such systems, while the necessary information is available to the OS for determining where (e.g., in which node of a multi-node system) particular data items are located, repeatedly querying the OS includes a relatively high overhead.

In view of the above, efficient methods and systems for efficiently processing data in a non-uniform memory access (NUMA) computing system are desired.

### SUMMARY OF EMBODIMENTS OF THE INVENTION

Systems and methods for efficiently processing data in a non-uniform memory access (NUMA) computing system are contemplated.

In various embodiments, a computing system includes multiple nodes in a non-uniform memory access (NUMA) configuration where the memory access times of local memory are less than the memory access times of remote memory. Each node includes a processing unit including one or more processors. The processors within the processing unit may include one or more of a general-purpose processor, a SIMD (single instruction multiple data) processor, a heterogeneous processor, a system on chip (SOC), and so forth. In some embodiments, a memory device is connected to a processor in the processing unit. In other embodiments, the memory device is connected to multiple processors in the processing unit. In yet other embodiments, the memory device is connected to multiple processing units.

Embodiments are contemplated in which a processor in a processing unit executes an instruction that identifies an address corresponding to a data location. The processor determines whether a memory device deemed local to the processing unit stores data corresponding to the address. In various embodiments, the determination is performed by generating a request to a memory manager or memory controller. In response to such a request, a hit or miss result indicates whether the address is mapped to the local memory device. A response indicating whether the address is mapped to the local memory device is then returned to the processor. Upon receiving the response, the processor completes processing of the instruction, which may include performing one or more steps, such as at least providing the indication of whether a local memory device stores data corresponding to the address for use by subsequent instructions in a computer program. Processing of the instruction is completed without the processor retrieving the data.

These and other embodiments will be further appreciated upon reference to the following description and drawings.

### BRIEF DESCRIPTION OF THE DRAWINGS

FIG. 1 is a generalized block diagram of one embodiment of a computing system.

FIG. 2 is a generalized flow diagram of one embodiment of a method for verifying whether a particular data object is stored in a given memory device without retrieving the data object.

FIG. 3 is a generalized flow diagram of one embodiment of a method for identifying the processor that is deemed local to the memory device storing a particular data object without retrieving the data object.

FIG. 4 is a generalized flow diagram of one embodiment of a method for determining a distance between a processor that is closest to the memory device storing a particular data object and a processor requesting the distance without retrieving the data object.

FIG. 5 is a generalized block diagram of another embodiment of a computing system.

FIG. 6 is a generalized flow diagram of another embodiment of a method for verifying whether a particular data object is stored in a given memory device without retrieving the data object.

FIG. 7 is a generalized flow diagram of another embodiment of a method for identifying the processor that is deemed local to the memory device storing a particular data object without retrieving the data object.

FIG. 8 is a generalized flow diagram of another embodiment of a method for determining a distance between a processor that is closest to the memory device storing a particular data object and a processor requesting the distance without retrieving the data object.

FIG. 9 is a generalized block diagram of one embodiment of multiple non-uniform memory access (NUMA) systems.

FIG. 10 is a generalized block diagram of one embodiment of scheduled assignments for hardware resources.

FIG. 11 is a generalized block diagram of one embodiment of code including an instruction extension to an instruction set architecture (ISA) to verify whether a given data item is stored in local memory.

FIG. 12 is a generalized flow diagram of one embodiment of a method for efficiently locating data in a computing system and processing only local data.

FIG. 13 is a generalized block diagram of another embodiment of scheduled assignments for hardware resources.

FIG. 14 is a generalized block diagram of embodiments of code including an instruction extension to an ISA to verify the location of a given data item and to process the given data item.

FIG. 15 is a generalized flow diagram of another embodiment of a method for efficiently locating data in a computing system and processing only local data.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention.

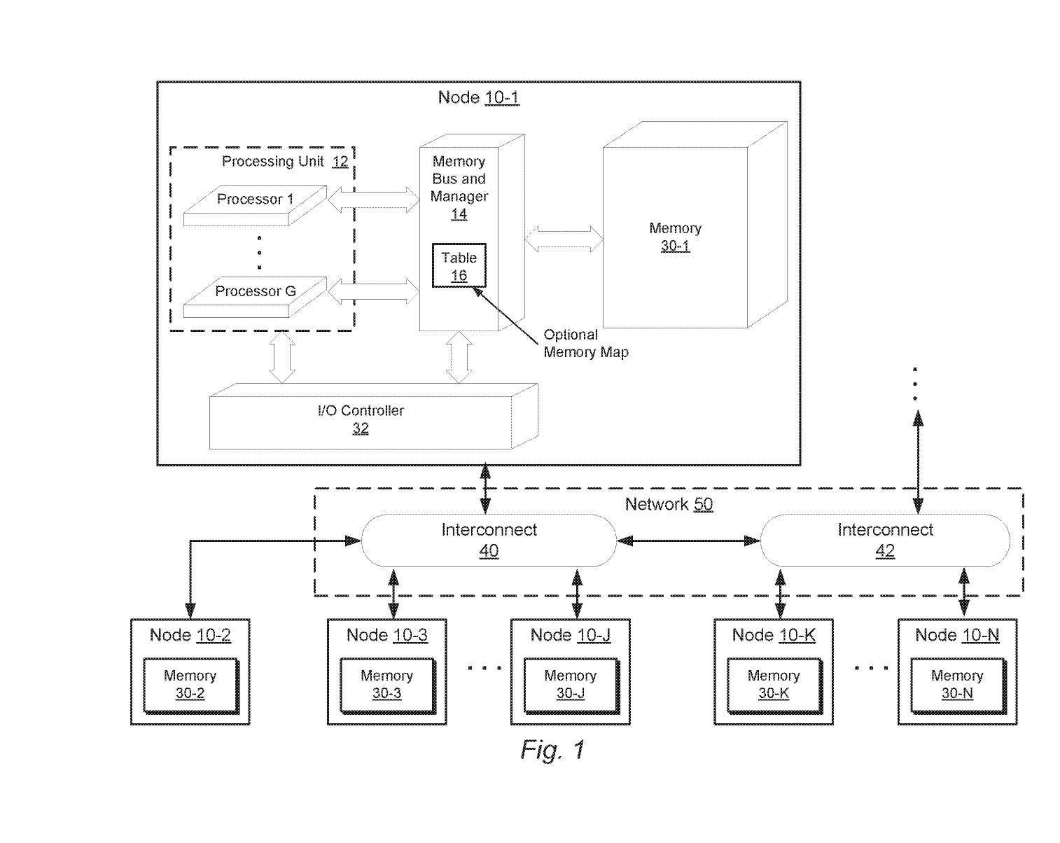

Referring to FIG. 1, a generalized block diagram of one embodiment of a computing system including multiple nodes is shown. Various embodiments may include any number of nodes in the computing system. As shown, the nodes 10-1 to 10-N use the network 50 for communication with one another. Two or more of the nodes 10-1 to 10-N may also use point-to-point interconnect links (not shown) for communication.

The components shown in node 10-1 may also be used within the nodes 10-2 to 10-N. As shown, node 10-1 includes a processing unit 12, which includes one or more processors. While the processing unit 12 is shown to include processors 1-G, any number of processors may be used. The processing unit 12 is connected to a memory bus and manager 14. In various embodiments, the one or more processors within the processing unit 12 of node 10-1 may include one or more processor cores. The one or more processors within the processing unit 12 may be a general-purpose processor, a SIMD (single instruction multiple data) processor such as a graphics processing unit or a digital signal processor, a heterogeneous processor, a system on chip (SOC) and so forth. The one or more processors in the processing unit 12 include control logic and circuitry for processing both control software, such as an operating system (OS) and firmware, and software applications that include instructions from one of several types of instruction set architectures (ISAs).

In the embodiment shown, node 10-1 is shown to include memory 30-1. The memory 30-1 may include any suitable memory device. Examples of the memory devices include RAMBUS dynamic random access memories (DRAMs), synchronous DRAMs (SDRAMs), DRAM, static RAM, three-dimensional (3D) integrated DRAM, etc. The memory 30-1 may be deemed local to node 10-1 as memory 30-1 is the closest memory of the memories 30-1 to 30-N in the computing system to the processing unit 12 of node 10-1. Similarly, the memory 30-2 may be deemed local to the one or more processors in the processing unit of node 10-2. Although node 10-1 is shown to include the memory 30-1, in other embodiments the memory 30-1 may be located external to node 10-1. In such an embodiment, node 10-1 may share a bus and other interconnect logic to the memory with one or more other nodes. For example, each of node 10-1 and node 10-2 may not include respective memories 30-1 and 30-2. Rather, node 10-1 and node 10-2 may share a memory bus or other interconnect logic to a memory located external to nodes 10-1 and 10-2. In such an embodiment, this external memory may be the closest memory in the computing system to nodes 10-1 and 10-2. Accordingly, this external memory may be deemed local to nodes 10-1 and 10-2 even though this external memory is not included within either of nodes 10-1 or 10-2.

Although processors typically include a cache memory subsystem, the nodes 10-1 to 10-N in the computing system may not cache copies of data. Rather, in some embodiments, only a single copy of a given data block may exist in the computing system. While the given data block may migrate from one node to another node, only a single copy of the given data block is maintained. In various embodiments, the address space of the computing system may be divided among the nodes 10-1 to 10-N. Each one of the nodes 10-1 to 10-N may include a memory map that is used to determine which addresses are mapped to which memory, and hence to which one of the nodes 10-1 to 10-N a memory request for a particular address should be directed.

In various embodiments, one or more of the nodes 10-1 to 10-N may issue a request to determine whether a memory device (e.g., which of 30-1 to 30-N) stores data corresponding to a particular address. In various embodiments, a hit or miss result for an access of a memory device indicates whether the memory device stores data corresponding to the address. It is noted the terms “hit” and “miss”, in the context of a memory (as opposed to a cache), indicate whether the address maps to that memory or not. As such, it is not necessary to access the memory to determine if particular data is stored there. A response with such an indication may then be returned to the requesting processor within the processing unit. In various embodiments, the request issued by the processor is configured to perform this determination without retrieving the data. For example, even in the case of a hit, the data is not retrieved. Rather, the requesting processor is simply advised of the hit or miss. In various embodiments, the processor performs this determination in response to processing a particular instruction that identifies the address corresponding to a memory location storing the data.

In various embodiments, the nodes 10-1 to 10-N are coupled to the interconnect 40 for communication and the nodes 10-K to 10-N are coupled to the interconnect 42 for communication. Each of the interconnects 40 and 42 may include routers and switches, and be coupled to other nodes, for transferring network messages and responses. In some embodiments, the interconnects 40 and 42 may include similar components but may be associated with separate sub-regions or sub-domains. Each of the interconnects 40 and 42 is configured to communicate with one another and may communicate with one or more other interconnects in other sub-regions or sub-domains. Various communication protocols are possible and are contemplated. The network interconnect protocol may include Ethernet, Fibre Channel, proprietary, and other protocols.

The input/output (I/O) controller 32 may communicate with an I/O bridge which is in turn coupled to an I/O bus. In some embodiments, the network interface for the node 10-1 may be included in the I/O controller 32. In other embodiments, the network interface for the node 10-1 is included in another interface, controller or unit, which is not shown for ease of illustration. Similar to the above, the network interface may use any of a variety of communication protocols. In various embodiments, the network interface responds to received packets or transactions from other nodes by generating response packets or acknowledgments. Alternatively, other units may generate such responses for transmission. For example, the network interface may generate new packets or transactions in response to processing performed by the processing unit 12. The network interface may also route packets for which node 10-1 is an intermediate node to other nodes.

The memory bus and manager 14 in node 10-1 may include a bus interfacing with the processing unit 12 and control circuitry for interfacing to memory 30-1. Additionally, memory bus and manager 14 may include request queues for queuing memory requests. Further, the memory bus and manager 14 shown in node 10-1 of FIG. 1 may include the table 16. In various embodiments, table 16 may be used to indicate which addresses are mapped to which memory device. For example, in some embodiments the table 16 includes a memory map used to map address spaces or ranges or memory devices. As noted above, in some embodiments data may migrate within the computing system and the information in the table 16 may be stale (i.e., it does not provide an up to date indication that a given memory address has moved from one location to another). Therefore, requests may still access the memory 30-1 to ensure the data is actually still stored (or not stored) in memory 30-1. As the table 16 may indicate the location where data is to be found within the system, the table may in some cases be referred to as a routing table. In some embodiments, the table 16 includes an identifier of a node for each memory location. However, other embodiments are contemplated. For example, in a computing system with a relatively large number of nodes it may not be desirable to store the identifier for each node and memory location. Rather, in some embodiments, the table 16 shown may store one or more of a port number, an indication of a direction for routing, or of an interconnect to traverse, an indication of a sub-region or a sub-domain, and so forth, for a given address or range of addresses. In this manner, the size of the table 16 may be reduced.

As described earlier, the processors in the processing unit 12 process instructions of an ISA for one or more software applications. In various embodiments, an instruction is used as an extension to an existing ISA. The instruction may be used to verify whether a given data item is stored in a memory device deemed local to the processor without retrieving the data item. In various embodiments, the instruction opcode mnemonic for this instruction is chklocal( ) although other mnemonics or names are also possible and contemplated.

As described earlier, the memory device deemed local to the processor may be either internal to the node or external to the node. In various embodiments, the determination as to whether a memory is deemed local may be based on the physical location of the memory device and/or access times to the memory device. For example, a memory device with a lower access latency may be deemed local in preference to a physically closer memory device with longer access latencies. Alternatively, the physically closer memory device may be deemed local even though another memory device has a lower access latency. Still further, other metrics may be used for determining whether a memory device is local. For example, metrics based on bus congestion, occupancy of request queues along a data retrieval path, assigned priority levels to processors or threads, and so forth, may be used in making such a determination. In a similar manner, a given data object may be deemed local to a given processor based on various criteria. In some embodiments, a given data object may be deemed local to a given processor if there is no other processor in the computing system that is closer than the given processor to the memory device storing the data object.

In various embodiments, a user-level instruction for performing the above determination as to whether a given memory location is local or not may be used. For example, a “check local” (or “chklocal( )”) instruction may be used to make such a determination. Such an instruction, and other instructions described herein, may represent an extensions to an existing instruction set architecture (ISA). As such, the chklocal( ) instruction may serve as an alternative to repeatedly querying the operating system, which includes high system call overhead. In some embodiments, an address is included with the request (e.g., as an input argument for the chklocal( ) instruction). In some embodiments, the address (virtual or otherwise) may be specified using the contents of a register. Alternatively, the address argument may be specified by the contents of a base register and an immediate offset value. The base register contents and the immediate offset value may be summed to form the address argument. In other embodiments, the address argument is specified by the contents of a base register and the contents of an offset register. In yet other embodiments, the address argument may be a value embedded in the instruction. Other ways for specifying the address argument for the chklocal( ) instruction are possible and are contemplated.

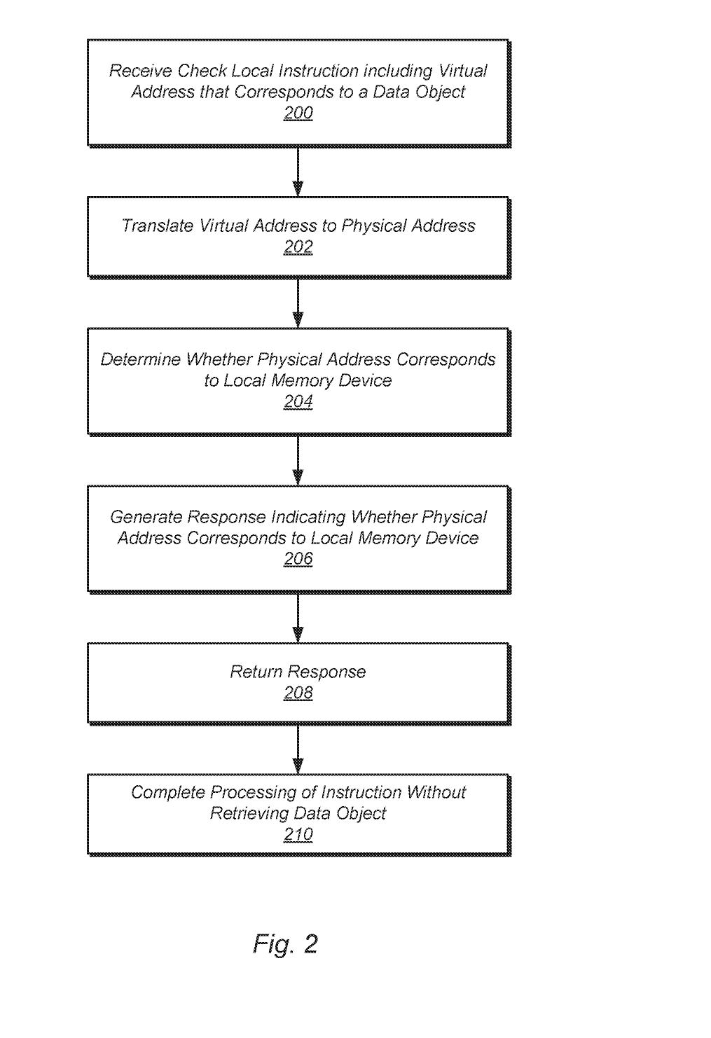

Turning now to FIG. 2, one embodiment of a method for verifying whether a particular data object is stored in a given memory device without retrieving the data object is shown. As used herein, data “object” may also be referred to as a data “block” or data “item.” In various embodiments, the data object may be one or more cache lines or cache blocks. In other embodiments, the data object is larger than a cache line, such as two or more cache lines or even larger such as a page of data. In yet other embodiments, the data object is smaller than a cache line, such as one or two bytes of data. Other data sizes for the data object are possible and contemplated. In various embodiments, the components embodied in the computing system in FIG. 1 may generally operate in accordance with the method of FIG. 2. For purposes of discussion, the steps in the method of FIG. 2, and of other methods described herein, are shown in sequential order. However, some steps may occur in a different order than shown, some steps may be performed concurrently, some steps may be combined with other steps, and some steps may be absent in another embodiment.

In the embodiment of FIG. 2, a processor processes instructions of a software application and encounters a chklocal( ) instruction (block 200). A virtual address argument of the chklocal( ) instruction corresponds to a particular data object. In block 202, the virtual address is translated to a physical address. In some embodiments, the processor performs the translation while in other embodiments logic external to the processor performs the translation. This translation, including the treatment of invalid virtual addresses, may utilize any of a variety of known techniques for translating virtual addresses to physical addresses. In block 204, the processor begins determining whether the physical address corresponds to a memory device deemed local to the processor. For example, executing the instruction may cause a corresponding request to the memory device.

Control logic in a memory manager or memory controller associated with the memory device may then receive the request. The memory controller may determine whether the physical address corresponds to the memory device. For example, an access request using the physical address may provide a hit or miss result for the memory device. A hit may indicate the memory device includes a storage location corresponding to the physical address. A miss may indicate the memory device does not include the storage location corresponding to the physical address. In either the hit case or the miss case, the data item corresponding to the storage location is not retrieved.

In block 206, the memory controller may generate a response indicating whether the physical address corresponds to the memory device. For example, the memory controller may include the hit or miss result in the response. In various embodiments, a Boolean value may be used to indicate the hit or miss result. As noted, the response does not include the data item corresponding to the physical address as the data item is not retrieved. In block 208, the response is conveyed to the processor. In block 210, the processor completes processing of the chklocal( ) instruction without retrieving the data object. The result in the response may be used by the processor to determine whether to continue processing of other program instructions or direct the processing to occur on another processor. For example, if the result indicates the data is present in the memory device, then processor may issue a request to retrieve the data. However, in various embodiments, absent a new request by the processor to retrieve the data, the data will not be retrieved.

In various embodiments, an instruction other than the chklocal( ) instruction may be used. For example, a “check local identifier” (“chklocali( )”) instruction may be used. Such an instruction may be used to identify the processor that is deemed local to the memory device storing a particular data object without retrieving the data object. In some embodiments, an identifier indicating a node which includes the processor is used to identify the processor. Generally speaking, the chklocali( ) instruction provides a user-level instruction for performing the above determination. As such, the chklocali( ) instruction may serve as an alternative to repeatedly querying the operating system, which includes high system call overhead. Similar to the chklocal( ) instruction, a virtual address is used as an input argument for the chklocali( ) instruction.

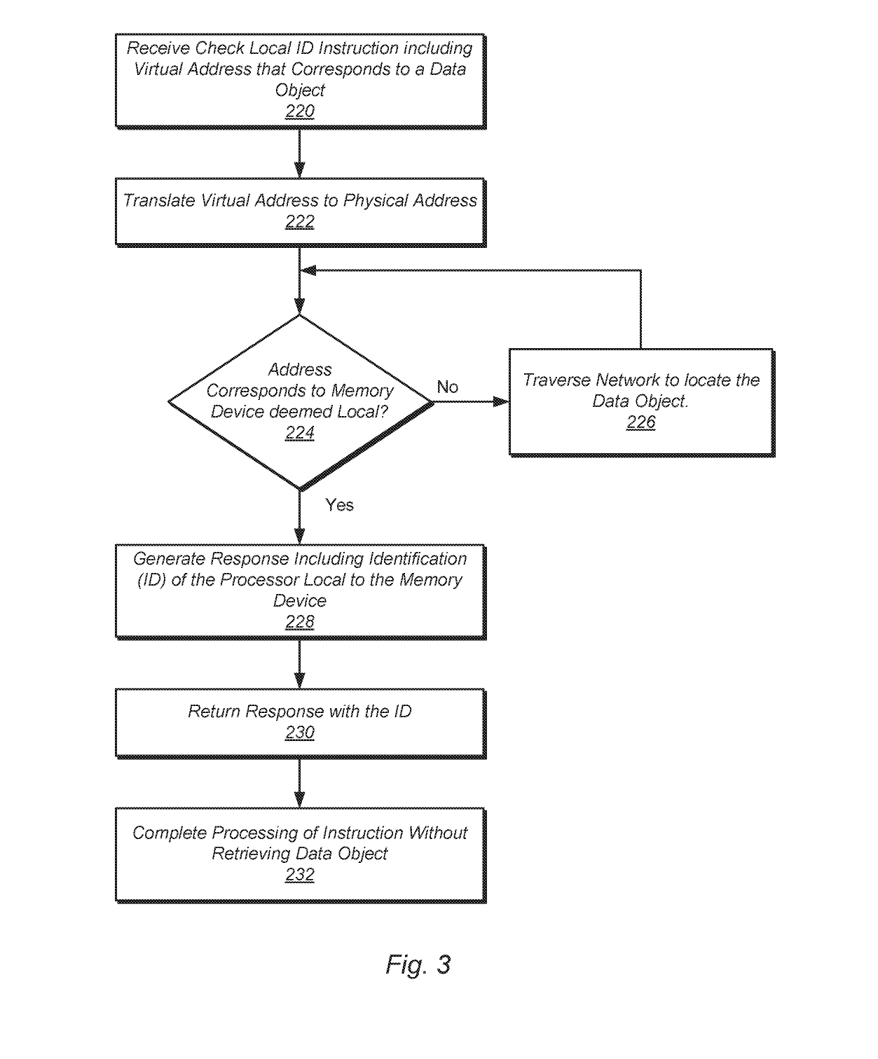

Referring now to FIG. 3, one embodiment of a method for identifying the processor that is deemed local to the memory device storing a particular data object without retrieving the data object is shown. Similar to the method in FIG. 2 and other methods described in the subsequent description, the components embodied in the computing system in FIG. 1 may generally operate in accordance with this method. In the example of FIG. 3, a processor processes instructions of a software application. In block 220, the processor receives a chklocali( ) instruction. A virtual address associated with the chklocali( ) instruction corresponds to a particular data object. In block 222, the virtual address is translated to a physical address. The processor begins the determination of identifying the processor that is deemed local to the memory device storing the particular data object. For example, the processor may issue a request to the memory device deemed local to it.

Control logic in a memory manager or memory controller associated with the memory device may receive the request. The memory controller may determine whether the physical address corresponds to the memory device. For example, an access request using the physical address may provide a hit or miss result for the memory device. In either the hit case or the miss case, the particular data object corresponding to the storage location identified by the physical address is not retrieved. If it is determined the physical address does not correspond to the memory device deemed local (conditional block 224), then in block 226, in some embodiments, a routing table may be accessed. The routing table may be similar to the table 16 described earlier in the illustrated example of node 10-1 of FIG. 1. A lookup into the routing table may provide a physical identifier (ID) of the node that includes the processor deemed local to the data object. In other embodiments, the network is traversed in order to locate the data object. For example, the memory controller may access a routing table to determine where to send an access request corresponding to the data object. The routing table may be similar to the table 16 described earlier in the illustrated example of node 10-1 of FIG. 1. When the access request reaches a destination, such as another node, the memory device deemed local to the destination is accessed and the conditional block 224 in the method is repeated.

If it is determined the physical address corresponds to the memory device deemed local (conditional block 224), then in block 228 a response is generated including an identification of the processor deemed local to the data object. For example, the memory controller corresponding to the memory device may insert an identification of the node that includes the processor. In various embodiments, the identification is a physical identifier (ID) of the node. In block 230, the response is returned to the processor processing the chklocali( ) instruction. In block 232, the processor completes processing of the chklocali( ) instruction without retrieving the data object. The result in the response may be used by the processor to determine whether to continue processing of other program instructions or direct the processing to occur on another processor.

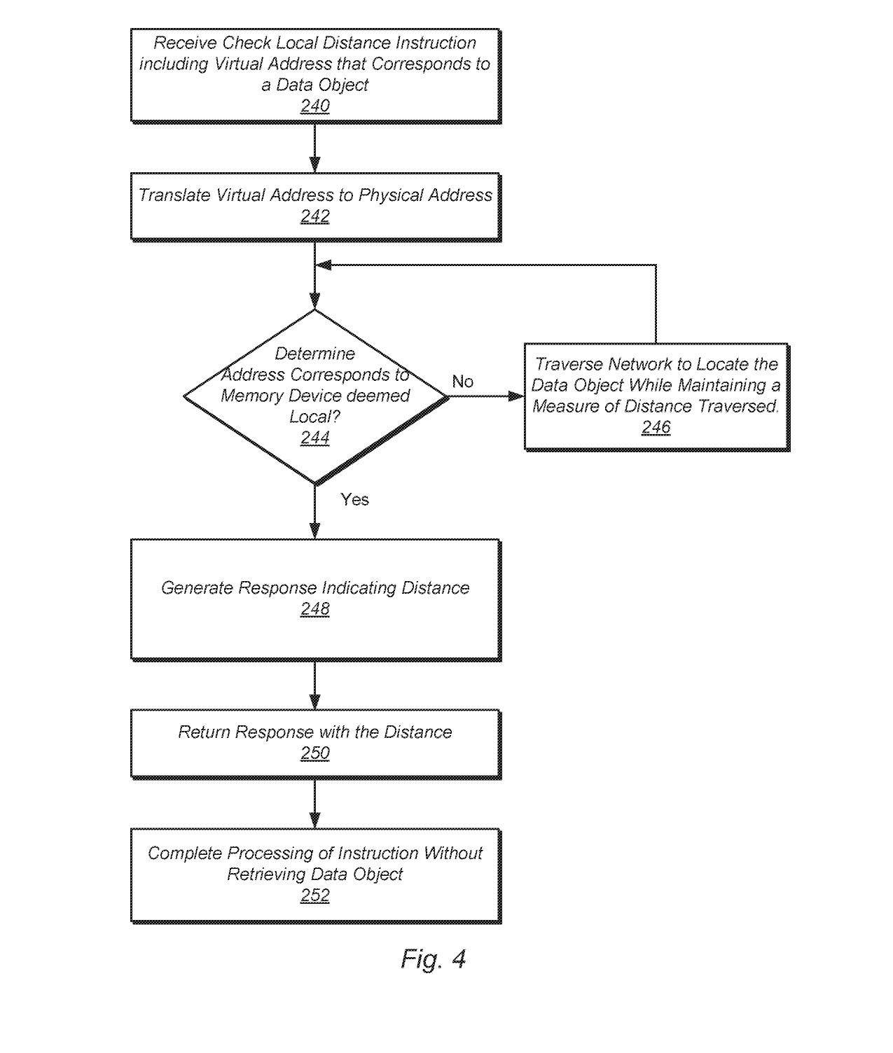

In various embodiments, other instructions may be used for determination a location of particular data. For example, a “check local distance” (or “chklocald( )”) instruction may be used to determine a distance between a processor executing the instruction and a processor that is closest to a memory device storing a particular data object. FIG. 4 illustrates one embodiment of a method for making such a determination. As before, the particular data object is not retrieved during the determination. In some embodiments, the distance is measured as a number of hops (e.g., between nodes or other transmitting entities) within a network from the processor requesting the distance to the processor deemed local to the memory device storing the particular data object. In the case when the requesting processor is also the processor deemed local to the memory device storing the particular object, the distance may be indicated as 0. In other cases, the distance may be a positive integer based on the number of hops, the number of sub-regions or sub-domains, the number of other nodes, and so forth. Other metrics used for the distance measurement are possible and are contemplated.

In block 240 of the example shown, the processor receives the chklocald( ) instruction. The virtual address corresponding to chklocald( ) instruction corresponds to a particular data object. In block 242, the virtual address input argument is translated to a physical address. The processor begins determining the requested distance. For example, the processor may issue a request to the memory device deemed local to it. Control logic in a memory manager or memory controller associated with the memory device receives the request and determines whether the physical address corresponds to the memory device. For example, an access request using the physical address may provide a hit or miss result for the memory device. In either the hit case or the miss case, the particular data object corresponding to the storage location identified by the physical address is not retrieved.

If it is determined that the physical address does not correspond to the memory device deemed local (conditional block 244), then in block 246, in some embodiments, a routing table may be accessed. The routing table may be similar to the table 16 described earlier in the illustrated example of node 10-1 of FIG. 1. A lookup into the routing table may provide a physical identifier (ID) of the node that includes the processor deemed local to the data object. In addition, a distance value may also be stored in the routing table indicating how far away the requested data object is from the node. If the requested data object is stored locally, in some embodiments the distance value is 0. When the requested data object is stored remotely on another node, the distance value may be a non-zero value indicative of the distance and discussed above.

In other embodiments, the network is traversed in order to locate the data object. For example, the memory controller may access a routing table to determine where to send an access request corresponding to the data object. During the traversal of the network, a distance is measured and maintained. For example, a count of a number of hops while traversing the network may be maintained. When the access request reaches a destination, such as another node, the memory device deemed local to the destination is accessed and the conditional block 244 in the method is repeated.

If it is determined the physical address does correspond to the memory device deemed local (conditional block 244), then in block 248 a response is generated including an indication of the distance. For example, the memory controller corresponding to the memory device may insert an indication of the measured distance into the response. In block 250, the response is returned to the processor that initiated the chklocald( ) instruction. In block 252, the processor completes processing of the chklocald( ) instruction without retrieving the data object. The result in the response may be used by the processor to determine whether to continue processing of other program instructions or direct the processing to occur on another processor. It is noted, in various embodiments, the steps performed for the chklocali( ) instruction and the chklocald( ) instruction may be combined. For example, a single instruction may be used to both identify the processor deemed local to the memory device storing the particular data object and report the measured distance to this processor from the processor requesting the distance.

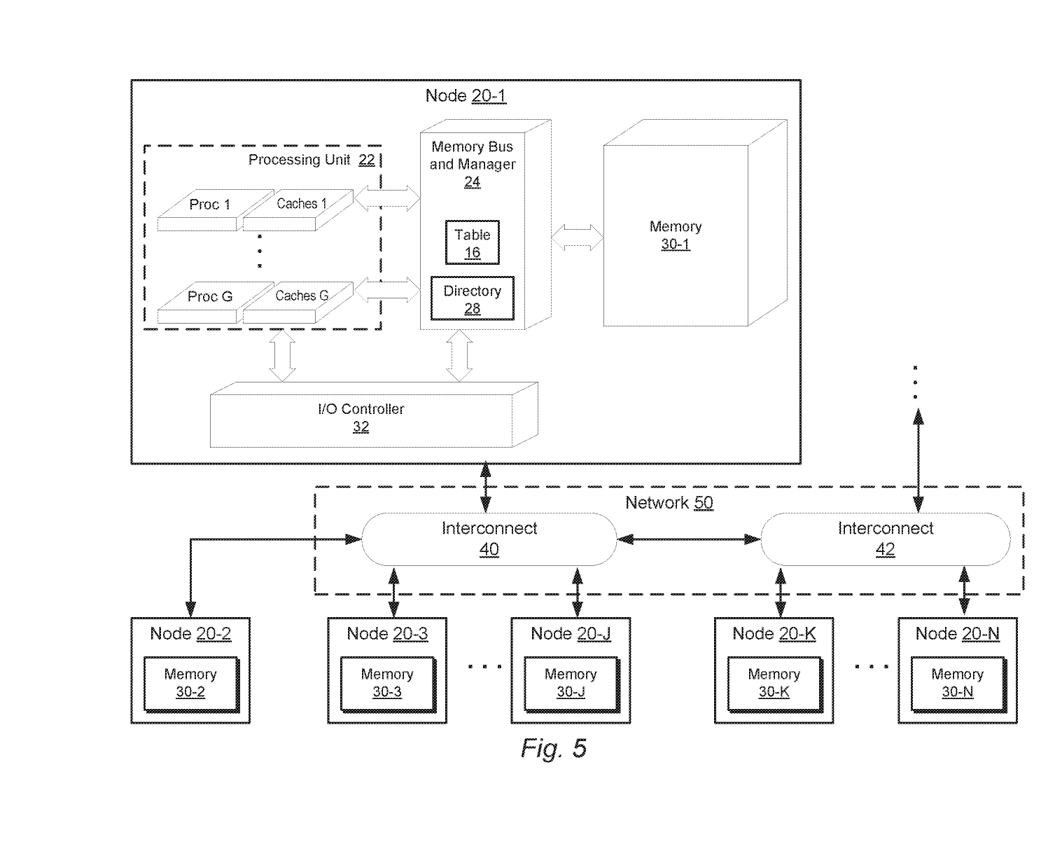

Referring to FIG. 5, a generalized block diagram of another embodiment of a computing system is shown. In contrast to the system of FIG. 1, the system illustrated in FIG. 5 may store more than one copy of a given data object. Control logic and circuitry described earlier are numbered identically. The computing system includes multiple nodes. Various embodiments may include any number of nodes in the computing system. As shown, the nodes 20-1 to 20-N use the network 50 for communication with one another. Two or more of the nodes 20-1 to 20-N may also use point-to-point interconnect links (not shown) for communication.

The components shown in node 20-1 may also be used within the nodes 20-2 to 20-N. In contrast to the earlier node 10-1, node 20-1 in the computing system includes one or more caches (1-G) as part of a cache memory subsystem. Generally, the one or more processors in the processing unit 22 access the cache memory subsystem for data and instructions. For example, processor 1 accesses one or more levels of caches (e.g., L1 cache, L2 cache) shown as caches 1. Similarly, processor G accesses one or more levels of caches shown as caches G. In addition, the cache memory subsystem of processing unit 22 may include a shared cache, such as a L3 cache. If the requested data object is not found in the cache memory subsystem in processing unit 22, then an access request may be generated and transmitted to the memory bus and manager 24. The memory bus and manager 24 in node 20-1 may include a bus interfacing with the processing unit 22 and control circuitry for interfacing to memory 30-1. Additionally, memory bus and manager 24 may include request queues for queuing memory requests. Further, the memory bus and manager 24 may include the table 16, which is described earlier in the illustrated example of node 10-1 of FIG. 1.

Further still, in some embodiments, the node 20-1 may include directory 28. In some embodiments, the directory 28 maintains entries for data objects stored in the cache memory subsystem in the processing unit 22 and stored in the memory 30-1. The entries within the directory 28 may be maintained by cache coherency control logic. In other embodiments, the directory 28 maintains entries for data objects stored only in the cache memory subsystem in the processing unit 22. In some embodiments, the presence of an entry in the directory 28 implies that the corresponding data object has a copy stored in the node 20-1. Conversely, the absence of an entry in the directory 28 may imply the data object is not stored in the node 20-1. In various embodiments, when a cache conflict miss occurs in any node of the nodes 20-1 to 20-N, corresponding directory entries in the nodes 20-1 to 20-N for the affected cache block may be updated.

In various embodiments, directory 28 includes multiple entries with each entry in the directory 28 having one or more fields. Such fields may include a valid field, a tag field, an owner field identifying one of the nodes 20-1 to 20-N that owns the data object, a Least Recently Used (LRU) field storing information used for a replacement policy, and a cache coherency state field. In various embodiments, the cache coherency state field indicates a cache coherency state according to the MOESI, or another, cache coherency protocol.

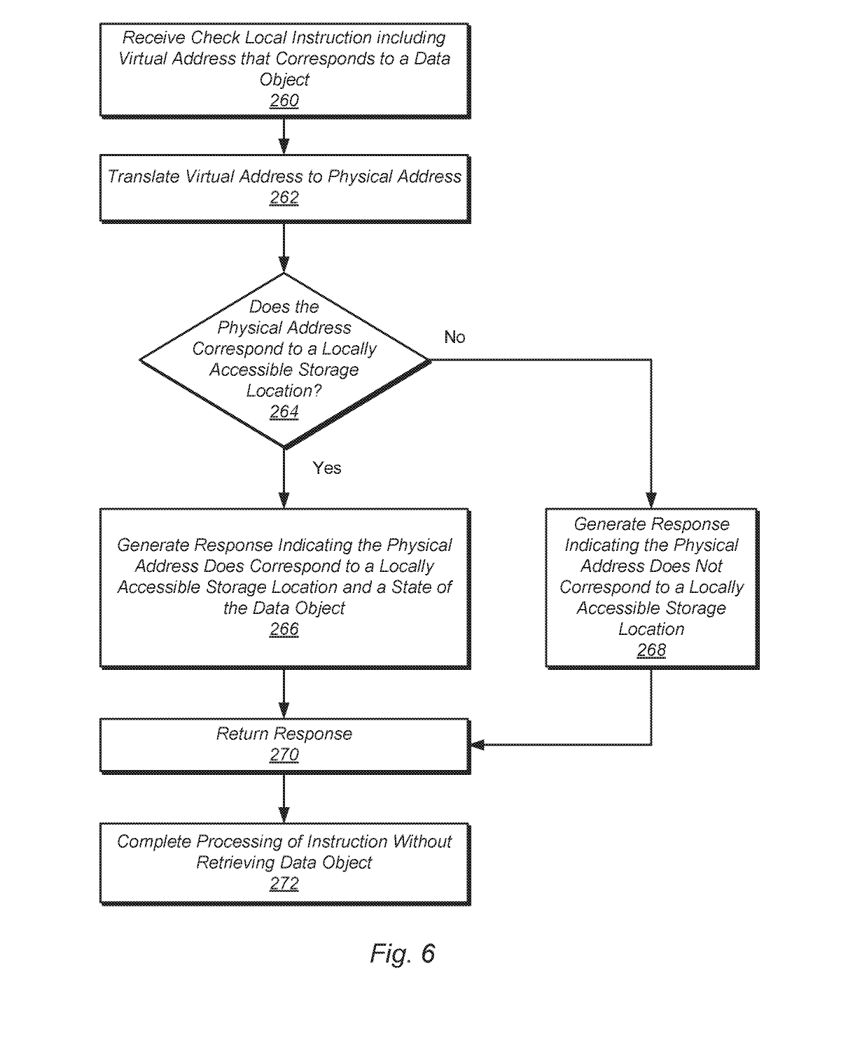

Turning now to FIG. 6, one embodiment of a method for verifying whether a particular data object is stored locally without retrieving the data object is shown. The components embodied in the computing system in FIG. 5 described above may generally operate in accordance with this method. In block 260 of FIG. 6, a processor receives a chklocal( ) instruction. A virtual address argument for the chklocal( ) instruction corresponds to a particular data object. In block 262, the virtual address is translated to a physical address as part of the processing of the instruction. As discussed above, a data object may be considered local to the processor when a memory device located closest to the processor (relative to any other processor) includes a memory location corresponding to the physical address of the data object.

In some embodiments, when processing a chklocal( ) instruction, an existing local cache memory subsystem is not checked for the presence of the corresponding data. Rather, the processor determines whether the physical address of the data object corresponds to a memory device deemed local to it. Whether or not the particular data object corresponding to the storage location identified by the physical address is present in the memory device, the particular data is not retrieved as part of the processing of the chklocal( ) instruction.

In other embodiments, a cache memory subsystem may be checked as part of the processing of a chklocal( ) instruction. For example, the processor may issue an access request to the cache memory subsystem. If a cache hit occurs for the cache memory subsystem, then the particular data object is determined to be in the cache and locally accessible to the processor. If a cache miss occurs for the cache memory subsystem, then the particular data object is determined to not be in the cache and the processor may then proceed with determining whether the corresponding address is mapped to a memory device that is deemed local to the processor. Whether or not the address is mapped to the local memory device, and whether or not the cache has a copy of the data object, the data object is not retrieved as part of the processing of the instruction.

In the case of a hit result for either the cache memory subsystem or the memory device (conditional block 264), in block 266 the corresponding controller (cache or memory) may generate a response indicating that the physical address corresponds to a data object stored locally with respect to the processor. For example, the corresponding controller may include the hit result in the response. In various embodiments, a Boolean value may be used to indicate the hit/miss result. In addition, the corresponding controller may insert cache coherency state information in the response. Other information, such as the owning node, may also be inserted in the response. In the case of a miss for both the cache memory subsystem and the memory device (conditional block 264), in block 268 the memory controller may generate a response indicating that the physical address does not correspond to a data object stored locally with respect to the processor. In block 270, the response is returned to the processor. Subsequently, the processor completes processing of the chklocal( ) instruction without retrieving the data object (block 272). This result may be used by the processor to determine whether to continue processing of other program instructions or direct processing to occur on another processor.

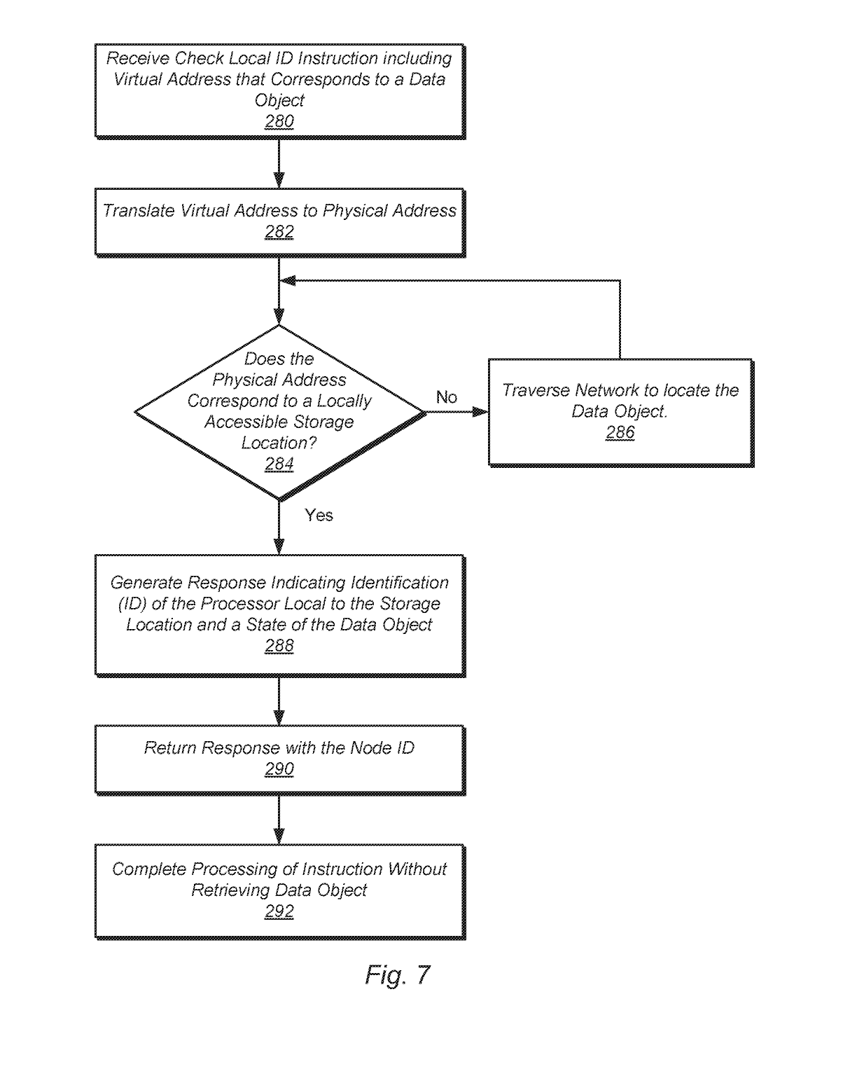

Turning now to FIG. 7, one embodiment of a method for identifying the processor that is deemed local to a storage location storing a particular data object is shown. In block 280, the processor receives a “chklocali( )” instruction. The virtual address associated with the chklocali( ) instruction corresponds to a particular data object. In block 282, the virtual address is translated to a physical address. Subsequently, the method continues with determining the identification of a node deemed local to the address. In the case of a miss for both a local cache memory subsystem and memory device (conditional block 284), in block 286 a routing table may be accessed. The routing table may be similar to the table 16 described earlier in the illustrated example of node 10-1 of FIG. 1. In some embodiments, the table may include an identification of the node that includes the processor deemed local to the data object and return such an identification in response to an access of the table.

Alternatively, in other embodiments the table may not include an identification of such a node. Rather, as discussed above, the table may store one or more of a port number, an indication of a direction for routing, or of an interconnect to traverse, an indication of a sub-region or a sub-domain, and so forth, for a given address or range of addresses. In such embodiments, a request may be conveyed via the network in order to locate the data object. For example, the memory controller may access the table to determine where to send a request that corresponds to the data object. When the access request reaches a particular destination, such as another node along a path, a cache memory subsystem, a directory and a memory device deemed local to the destination is accessed and the conditional block 284 in the method is repeated as needed.

When a request reaches a particular destination, in the case of a hit for either a cache memory subsystem or a memory device associated with the destination (conditional block 284), in block 288 the corresponding controller (cache or memory) may generate a response including an identification of the processor that is deemed local to the data object. In various embodiments, the indication is an identifier usable to uniquely identify the node within the system. As before, the response does not include the data object. In addition, the corresponding controller may insert cache coherency state information in the response. Other information, such as the owning node, may also be inserted in the response. In some embodiments, a hit may occur for the home node of the data object (i.e., the node for which the data object is deemed local). In some embodiments, a hit may occur for a node that currently owns the data object (e.g., a node that is not the home node for the data object but currently owns a copy of the data object). In yet other embodiments, a response may include information for both the owning node and the home node when these two nodes are different nodes for the data object. In block 290, the response is returned to the processor and the processor completes processing of the chklocali( ) instruction without retrieving the data object (block 292).

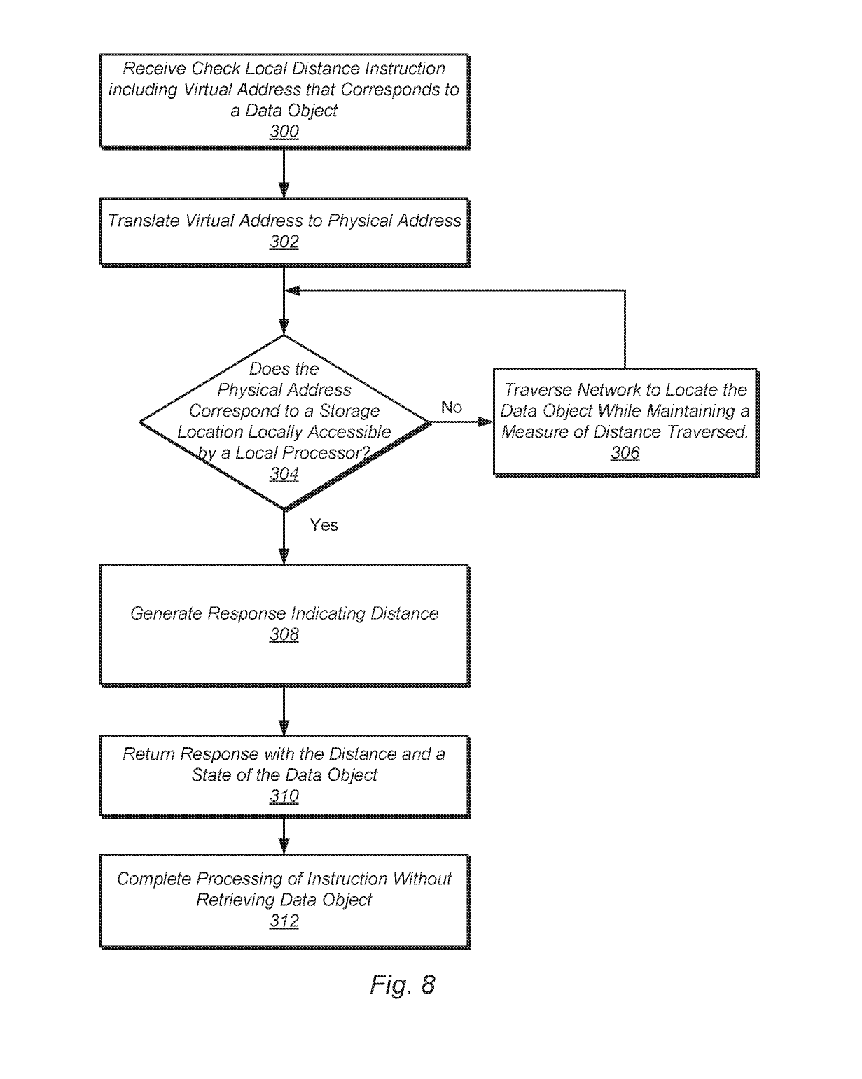

Turning now to FIG. 8, one embodiment of a method for determining a distance between a processor deemed local to a memory device storing a particular data object and a processor requesting the distance is shown. In block 300 the processor receives a check local distance (chklocald( ) instruction and a virtual address associated with the instruction is translated to a physical address (block 302). In the case of a miss for both the cache memory subsystem and the memory device (conditional block 304), in block 306 a table may be accessed. Per the discussion above of FIG. 7 above, the table may be similar to the table 16 described earlier. A lookup into the table may provide an identification of a node that includes the processor deemed local to the data object. Further, in some embodiments, the table may also indicate a distance between the processor executing the instruction and a processor that is deemed local for the data object. In such a case, a response may be returned that identifies either or both of the processor and its distance. In other embodiments, the network is traversed in order to locate the data object. For example, the memory controller may access a routing table to determine where to send an access request corresponding to the data object. During the traversal of the network, a distance is measured and maintained. For example, a count of a number of hops while traversing the network may be maintained. When the access request reaches a destination, such as another node, the memory device deemed local to the destination is accessed and the conditional block 304 in the method is repeated. Once a destination has been reached and a hit results for either the cache memory subsystem or the memory device (conditional block 304), in block 308 the corresponding controller (cache or memory) may generate a response including an indication of the measured distance. However, the data object itself is not returned. In addition, the corresponding controller may insert cache coherency state information in the response. Other information, such as an identification of an owning node, may also be inserted in the response. In some embodiments, a hit result may occur only for the owning node for the data object. In other embodiments, the hit result may occur for the home node for the data object. In yet other embodiments, a response is expected to include information for each of the owning node and the home node when these two nodes are different nodes for the data object. In block 310, the response is returned to the processor and the processor completes processing of the chklocald( ) instruction without retrieving the data object (block 312).

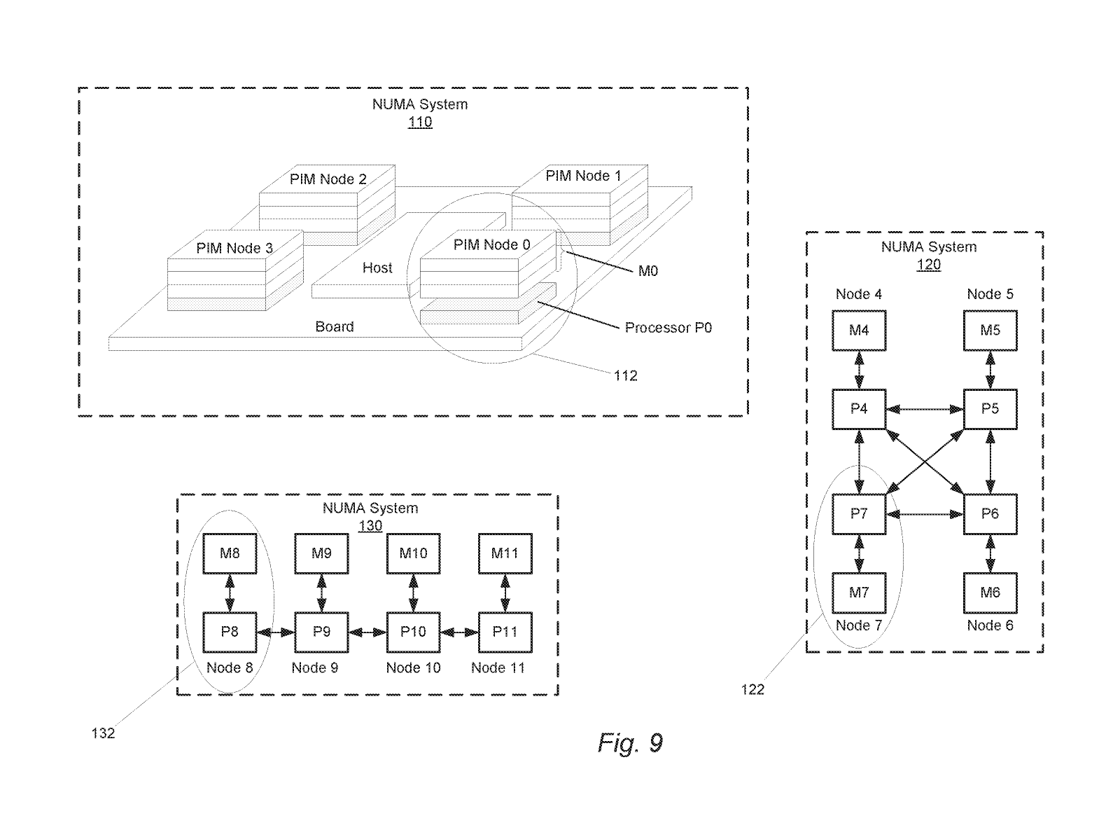

Referring to FIG. 9, various embodiments of non-uniform memory access (NUMA) systems (110, 120, and 130) are shown. Each of the systems (110, 120, and 130) includes multiple nodes. For example, system 110 includes node 112 and three other similar nodes. System 120 includes node 122, and three other similar nodes. Finally, system 130 includes node 132 and three other similar nodes. Each of the nodes includes one or more processors coupled to a respective local memory. In the example shown, system 110 illustrates a processing-in-memory (PIM) based system comprising PIM nodes (i.e., PIM Node 0-PIM Node 3). Generally speaking, a PIM node includes the integration of a processor with RAM on a single chip or package. This is in contrast to the system 120 and 130 with traditional topologies in which a processor is coupled to an external memory device via interconnect(s).

In the example of system 110, node 112 (PIM Node 0) includes a processor P0 and memory M0. Each of the memories in the nodes of system 112 may include a three-dimensional (3D) integrated DRAM stack to form the PIM node. Such a 3D integrated DRAM may include two or more layers of active electronic components integrated both vertically and horizontally into a single circuit saving space by stacking separate chips in a single package. For ease of illustration, the processor P0 and memory M0 are separated to clearly illustrate the node 112 includes at least these two distinct elements. In system 120, processor P7 is coupled to a local memory M7 to form a node 122, Node 7. The processor P5 is coupled to the local memory M5 to form a second node, Node 5, and so on. Similarly, in the system 130, the processor P8 is coupled to the local memory M8 to form a first node 132, Node 8, and so on. It is noted that while each of the systems illustrated in FIG. 9 have four nodes, other embodiments may have different numbers of nodes.

In various embodiments, nodes in a system may or may not be coupled directly to all other nodes in the system. For example, each node in the system 130 is not directly coupled to all other nodes in the system. For example, node 8 is not directly coupled to nodes 10 or 11. In order for node 8 to communicate with node 10, it must communicate through node 9. In contrast, system 120 shows each of the nodes (4-7) has a direct connection to all other nodes (i.e., the nodes are fully interconnected). Similar to system 120, system 110 may also have all nodes be fully interconnected.

Finally, in various embodiments an address space for each of the systems 110-130 is divided among the nodes. For example, an address space for system 110 may be divided among the nodes (PIM Nodes 0-3) and corresponding data stored with the PIM nodes. In this manner, data in the system will generally be distributed among the nodes. In such embodiments, each node within the system may be configured to determine whether or not an address is mapped to it.

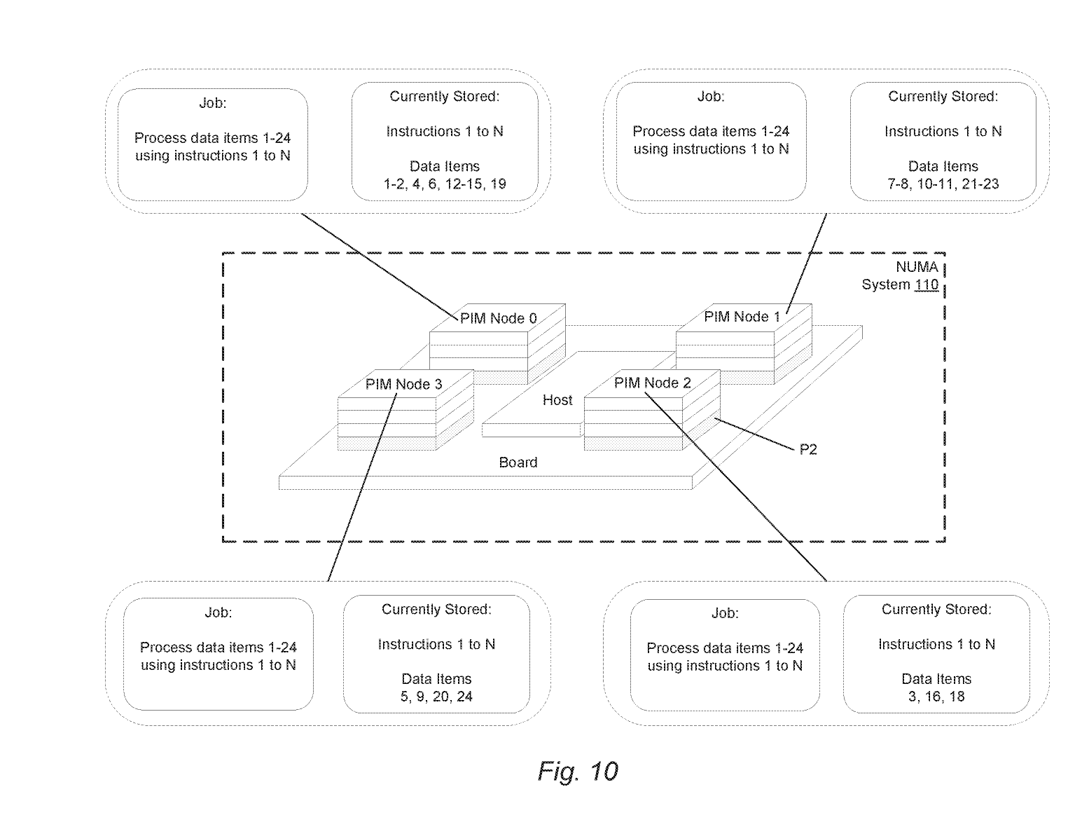

Turning now to FIG. 10, a generalized block diagram illustrating one embodiment of scheduled instructions and assigned data items on multiple nodes in a system is shown. For purposes of discussion, a PIM based system is used. However, the methods and mechanisms described herein may be used in non-PIM based systems as well. As shown, each of the nodes 0-3 in system 110 stores instructions 1 to N as indicated by the “Currently Stored” block. The Currently Stored block also indicates which data items are currently stored by the given PIM node. For example, PIM Node 3 only stores data items 5, 9, 20 and 24 of the data items 1-24. Nevertheless, even though each node only stores a subset of the data items, each node is given the task or “job” of using the instructions 1-N to process data items 1 to 24. It is noted that while the term job is used herein, a job does not necessarily indicate a package, per se, that identifies both instructions and data. While such an embodiment is possible, in other embodiments the instructions and data items may be separately identified at different points in time and in a variety of ways. Generally speaking, any suitable method for identifying particular instructions and data items are contemplated.

In various embodiments, the location of the data items 1-24 may be unknown prior to processing the instructions 1 to N among the nodes 0-3. In other embodiments, an initial allocation of the data items among the nodes may be known. However, even in such embodiments, data migration may have occurred and changed the locations of one or more data items from their original location to a new location. Such migration may occur for any of a variety of reasons. For example, the operating system (OS) may perform load balancing and move data items, the OS may remove mappings for pages and move the pages to disk, advanced memory management systems may perform page migrations, copy-on-write operations may be executed, another software system or application may perform load balancing or perform an efficient data storage algorithm that moves data, and so forth. Therefore, one or more of the data items 1-24 used by the set of instructions 1 to N may not be located in an originally assigned location. In addition, in various embodiments a given node does not have information that indicates where a particular data item may be if it is not stored locally.

In the example shown, the local memory M0 in the node 0 currently stores the data items 1-2, 4, 6, 12-15 and 19. These data items 1-2, 4, 6, 12-15 and 19 may be considered locally stored or stored local for the processor P0 that processes the set of instructions 1 to N using these data items. In some embodiments, a lookup operation may be performed by the processor P0 in the node 0. A successful lookup for a given data item may indicate that the given data item is locally stored for the processor directly connected to the local memory.

As the data items 1-2, 4, 6, 12-15 and 19 are locally stored in node 0, processor P0 in the node 0 may process these data items using instructions 1 to N. However, in various embodiments, data items that are not locally stored are not processed by the local node. For example, data item 3 will not be processed by node 0. Rather, the processor P2 in the node 2 is able to process the set of instructions 1 to N for the data item 3 as the local memory M2 stores the data item 3.

As is well known in the art, when a node does not have a requested data item, migration is typically performed. In one example, data migration is performed by node 0 to retrieve data item 3 from node 2. Alternatively, in conventional cases, thread migration may be performed by node 0 to migrate a thread from node 0 to node 2 which stores the desired data item 3. However, in various embodiments, no data migration and no thread migration is performed. Rather, when a given node determines a given data item is not locally stored, processing effectively skips the missing data items and continues with the next data item. Similarly, each node in the system performs processing on data items which are locally stored and “skips” processing of data items that are not locally stored. In this manner, node 0 processes data items 1-2, 4, 6, 12-15, and 19. Node 1 processes data items 7-8, 10-11, and 21-23. Node 2 processes data items 3, 16 and 18. Finally, node 3 processes data items 5, 9, 20, and 24.

In various embodiments, when a node determines that a given data item is not locally stored, it does not communicate this fact in any way to other nodes of the system. As such, the missing data items is simply ignored by the node and processing continues. In various embodiments, all data items 1-24 have been allocated for storage somewhere within the system. Consequently, it is known that every data item 1-24 is stored locally within one of the nodes. Additionally, instructions 1 to N are locally stored within each node in the system that will be processing the data items. Given the above described embodiment which effectively ignores missing data items, processes those that are locally present, and does not provide an indication to other nodes regarding missing data items, methods and mechanisms are utilized to ensure that all data items (i.e., 1-24) are processed. Accordingly, in various embodiments, the same “job” is provided to each node in the system. In this case, the job is to processes data items 1-24 using instructions 1 to N. Accordingly, each node will process all data items of the data items 1-24 that are locally stored. As all data items 1-24 are known to be stored in at least one of the nodes, then processing of all data items 1-24 by the instructions 1 to N is ensured.

In various embodiments, when a given data item is the last data item of the assigned data items in a node and there are no more available data items remaining, processing of the instructions 1-N in the node ceases. In some embodiments, a checkpoint may be reached in each node which may serve to synchronize processing in each node with the other nodes. For example, in various embodiments processing of all data items by the instructions may be considered a single larger task which is being completed in a cooperative manner by multiple nodes of the system. A checkpoint or barrier type operation in each node may serve to prevent each node from progressing to a next task or job until the current job is completed. In various embodiments, when a given node completes its processing of data items it may convey (or otherwise provide) an indication that is received or observable by system software or otherwise. When the system software detects that all nodes have reached completion, each node may then be released from the barrier and may continue processing of other tasks. Numerous such embodiments for synchronizing processing of nodes are possible and are contemplated.

In some embodiments, the checking of data items to determine whether they are locally stored may be performed one at a time. For example, a given node checks for data item 1 and if present, processes the data item before checking for the presence of data item 2. In other embodiments, there may be an overlap of checking for data items. For example, while processing a given data item, the node may concurrently check for the presence of the next data item. Still further, in some embodiments, a check for the presence of all data items in a set may be performed prior to any processing data items with the instructions. Taking node 0 as an example, checks may be performed for all data items 1-24 prior to any processing of the set of instructions 1 to N. An indication may then be created to identify which data items are present (and/or not present). For example, a bit vector could be generated in which a bit is used to indicate whether a particular data item is present locally. Various embodiments could also combine any of the above embodiments as desired.

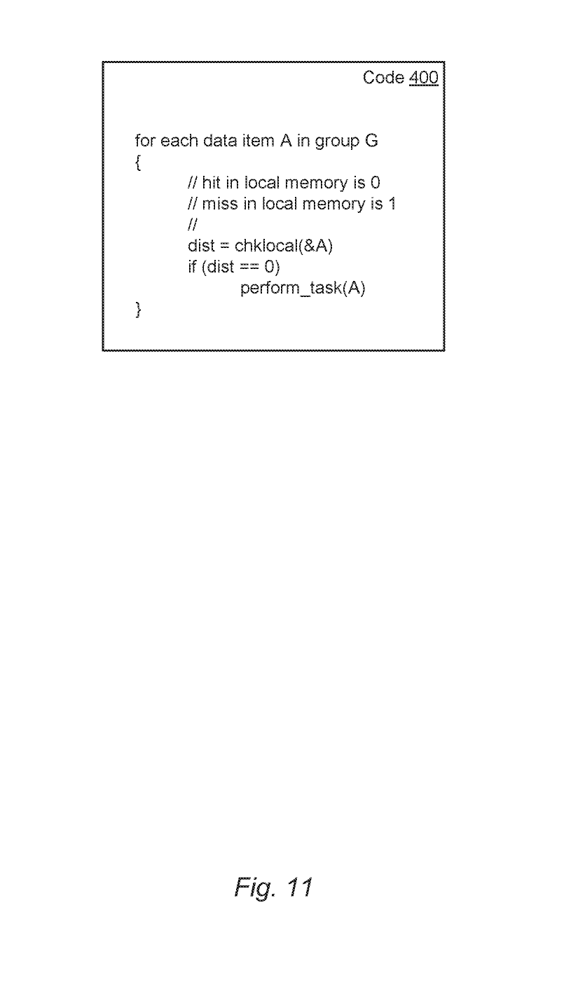

Referring now to FIG. 11, one embodiment of pseudo code 400 including an instruction extension to an instruction set architecture to verify whether a given data item is stored in local memory of a node is shown. In the example shown, the instruction is the chklocal( ) instruction. Generally speaking, the chklocal( ) instruction provides a user-level instruction that determines whether a given data item is locally stored in a node. As such, the chklocal( ) instruction may serve as an alternative to repeatedly querying the operating system, which includes high system call overhead.

In various embodiments, the chklocal( ) instruction receives as an argument an indication of an address corresponding to a data items (e.g., a virtual address) and returns an indication of whether a data item associated with the address is stored in a local memory of the particular node. In various embodiments, the indication returned may be a Boolean value. For example, a binary value of 0 may indicate the associated data item is found and a binary value of 1 may indicate the associated data item is not found in the local memory of the particular node. In the example shown, a variable “dist” is assigned the returned Boolean value. Other values for the indications are possible and contemplated.

One example use of the code 400 is to have the code 400 executed on each node within a system such as that of FIG. 10, where processing of all data items is assigned to each node. In an embodiment where the data items are distributed for storage among the nodes, and nodes only process data items that are local to the node, only one node of the multiple nodes will find the data item associated with the virtual address “A” stored in its local memory. It is noted that in various embodiments, a given data item is local to a node if the node is a “home node” for the data items. In other words, the given data item has been purposely assigned to the node for storage by an operating system or other system level software. Further, in some embodiments, a given data item may not exist in more than one node at a time. For example, if a data item X is currently assigned to Node X, then no other node may currently have a copy of data item X. Further, in various embodiments, nodes in a system may not request a copy of a data item that is not local to the node. As such, it is only possible for a node to process data items that are local to the node.

Referring again to FIG. 10, in some embodiments, only node 2 in the system stores the data item 3 in its local memory, which is local memory M2. Each of node 0, node 1 and node 3 will not find the data item 3 in their respective local memories M0, M1 and M3. However, each of the nodes 0-3 will search for the data item 3 when executing the code 400. As only node 2 will find data item 3 to be local (and the variable dist is set to 0), only node 2 will execute the instructions for the function “perform_task” using the data item 3. Node 0, node 1 and node 3 will proceed to continue the loop (the for loop) in the code 400 with no further processing with the data item 3.

In various embodiments, when executing the chklocal( ) instruction, each of the nodes 0-3 may translate the virtual address “A” to a physical address. A translation lookaside buffer (TLB) and/or a page table may be used for the virtual-to-physical translation. The physical address may be used to make a determination of whether the physical address is found in the local memory. For example, a lookup operation may be performed in the memory controller of the DRAM directly connected to the one or more processors of the node.

In some embodiments, during processing of the chklocal( ) instruction, the determination of whether the physical address is associated with a data item stored in the local memory may utilize system information structures that store information for the processors and memory. These structures may identify the physical locations of the processors and memory in the system. The operating system may scan the system at boot time and use the information for efficient memory allocation and thread scheduling. Two examples of such structures include the System Resource Affinity Table and the System Locality Distance Information Table. These structures may also be used to determine whether a given data item is locally stored for a particular node. When the above determination completes, a state machine or other control logic may return an indication whether a physical address is associated with a data item stored in the local memory. The processing of the chklocal( ) instruction may be completed without retrieving the data corresponding to the physical address.

As noted, in some embodiments processing of the instructions of the function “perform_task( )” may be overlapped with processing of the chklocal( ) instruction. For example, processing of the instructions for perform_task(A0) may be overlapped with processing of the instruction chklocal(A1). In addition, each of the chklocal( ) instructions and the instructions in the function perform_task( ) may receive multiple data items concurrently as input arguments if the processor within the node supports parallel processing. Further, in some embodiments, the chklocal( ) instruction may receive an address range rather than a single virtual address as an input argument and may only indicate the data is local if the entire range is stored in the local memory.

In some embodiments, a software programmer inserts the chklocal( ) instruction in the code 400. In other embodiments, the chklocal( ) instruction may be inserted by a compiler. For example, a compiler may analyze program code, determine that the function perform_task( ) is a candidate function call to be scheduled on the multiple nodes within a system for concurrent processing of its instructions and accordingly insert the chklocal( ) instruction. In some embodiments, older legacy code may be recompiled with a compiler that supports a new instruction such as chklocal( ) In such embodiments, the instruction may be inserted into the code—either in selected cases (e.g., responsive to a compiler flag) or in all cases. In some cases, the instruction is inserted in all cases, but is conditionally executed (e.g., using other added code) based on command line parameters, register values that indicate a given system supports the instruction, or otherwise. Numerous such alternatives are possible and are contemplated.

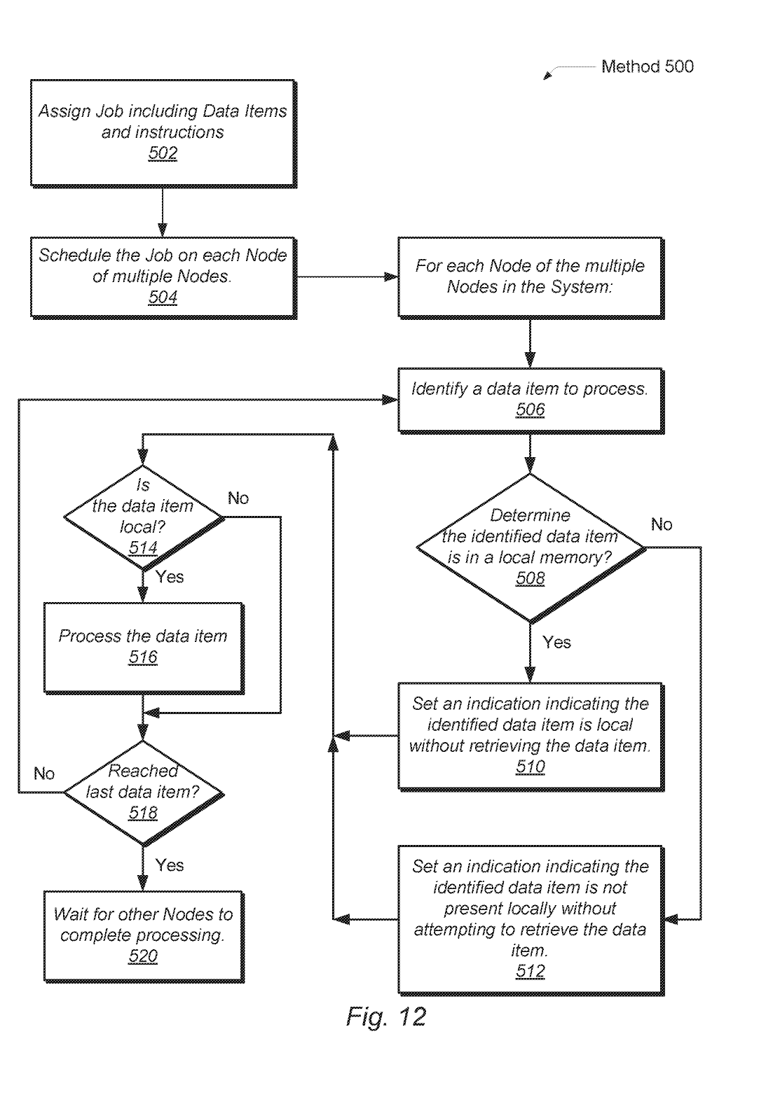

Turning now to FIG. 12, one embodiment of a method 500 for identifying a location of data in a non-uniform memory access (NUMA) computing system is shown. The components embodied in the NUMA systems 110-130, the hardware resource assignments shown in FIG. 10, and the processing of the chklocal( ) instruction in the code 400 described above may generally operate in accordance with method 500.

In block 502, one or more data items are assigned for processing by instructions. In block 504, the set of one or more instructions are scheduled to be processed on each node of multiple nodes of a NUMA system. For each node of the multiple nodes in the system, in block 506, a data item is identified to process. For example, a virtual address, an address range, or an offset with an address may each be used to identify a data item to process. Whether multiple data items are processed concurrently or a single data item is processed individually is based on the hardware resources of the one or more processors within the nodes 0-3.

During processing of program instructions, each of the nodes may perform a check to verify whether the identified data item is stored in local memory. In various embodiments, an instruction extension, such as the instruction chklocal( ) described earlier, may be processed. If the identified data item is determined to be stored in the local memory (conditional block 508), then in block 510, an indication may be set indicating the identified data item is local without retrieving the data item. In some embodiments, during the check a copy of the data item is not retrieved from the local memory. In other words, the check does not operate like a typical load operation which retrieves data if it is present. If the identified data item is determined to not be stored in the local memory (conditional block 508), then in block 512, an indication may be set that indicates the identified data item is not present. In various embodiments, no further processing with regard to the missing data item is performed by the node, no request for the missing data items is generated, and no attempt is made to retrieve the data item or identify which node stores the identified data item.

If the identified data item is local (conditional block 514), then in block 516 the data item is retrieved from the local memory and processed. For example, a load instruction may be used to retrieve the data item from the local memory. If the identified data item is not stored locally, then processing of instructions may proceed to a next instruction corresponding to a next data item without further processing being performed for the identified data item. If the last data item is reached (conditional block 518), then in block 520, the node may wait for the other nodes in the system to complete processing of the instructions before proceeding. For example, a checkpoint may be used.

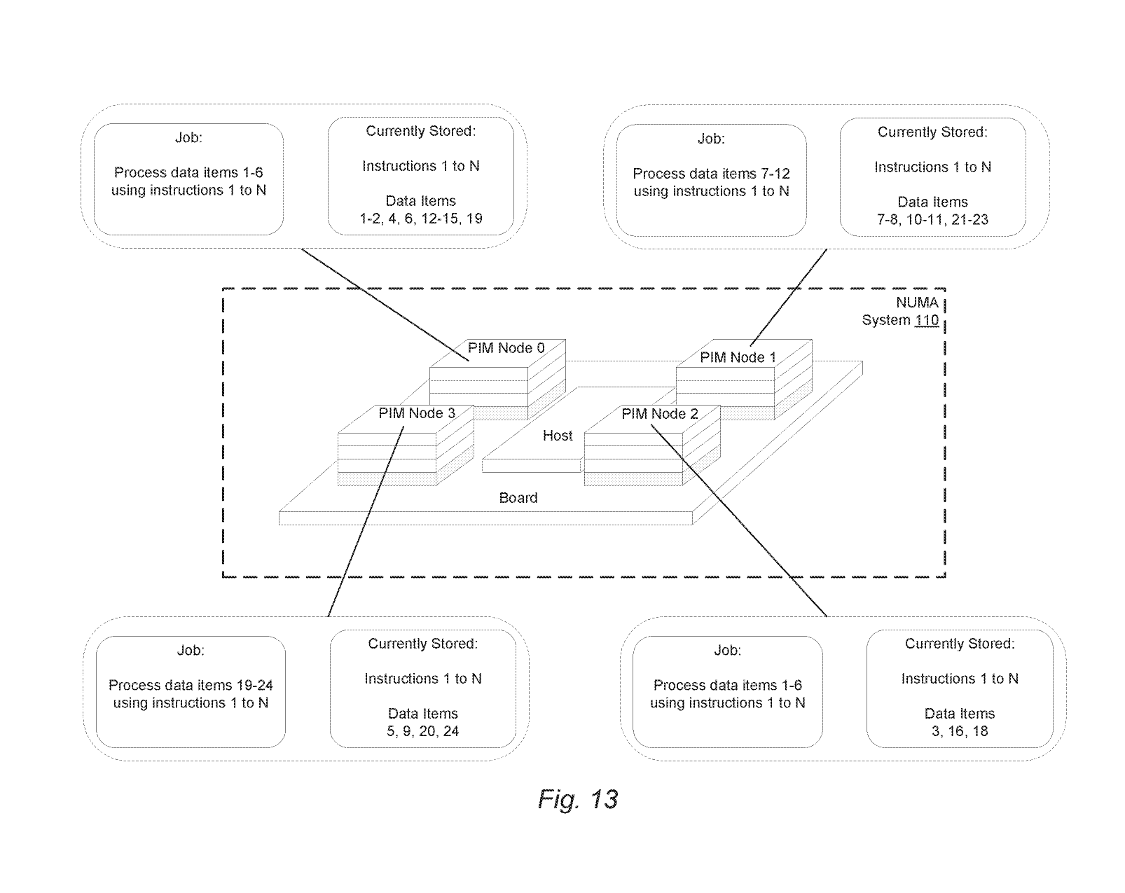

Turning now to FIG. 13, a generalized block diagram illustrating another embodiment of scheduled instructions and assigned data items on multiple nodes in a system is shown. As shown in the earlier example, each of the nodes 0-3 in the PIM chip of the NUMA system 110 stores a set of instructions 1 to N. In this example, each of the nodes 0-3 is assigned a non-overlapping subset of data items of the data items 1-24. For example, the node 0 is assigned data items 1-6, the node 1 is assigned the data items 7-12, the node 2 is assigned the data items 13-18 and the node 3 is assigned the data items 19-24.

In this embodiment, the locations of the data items 1-24 is not known. Therefore, one or more of the data items 1-24 assigned to a particular node may not be locally stored on the particular node. For example, the data items 1-6 may have been initially assigned for storage on the local memory M0 in node 0. However, over time, the data items migrated or moved for multiple reasons as described earlier. Now, rather than storing the data items 1-6, the local memory M0 in node 0 stores the data items 1-2, 4, 6, 12-15 and 19.

Rather than perform data migration or thread migration, in some embodiments, each of the nodes 0-3 may send messages to the other nodes identifying data items not found in the node. For example, if node 0 determines that data items 1-3 are stored locally and data items 4-6 are not, then node 0 may convey a message that identifies data items 4-6 to one or more of the other nodes (nodes 1-3). Additionally, in some embodiments, node 0 may also convey an indication to the other nodes that identifies the set of instructions 1 to N. After sending the messages to the other nodes, the transmitting node may process the data items determined to be local and bypass those determined not to be local. In various embodiments, each of the nodes receiving the message then checks to determine if the identified data items are local to the receiving node. If it is determined that one or more of the data items are local to the receiving node, then the receiving node may process those data items using the appropriate instructions (e.g., which may have also been identified by the transmitting node). In various embodiments, receiving nodes may or may not provide any indication regarding whether a data item was found and/or processed.

In some embodiments, the receiving nodes may provide a responsive communication such as an indication identifying itself, such as a node identifier (ID), and a status whether or not the identified data item is stored in respective local memory. In response to identifying the particular node that locally stores the given data item, the transmitting node may send a message to the particular node instructing that the node process those data items that were found to be local.

Taking node 1 as an example in FIG. 13, the node 1 determines it has the data item 7 stored in its local memory. The node 1 processes data item 7 using instructions 1-N. Similarly, responsive to determining the data item 8 is stored in its local memory, node 1 processes data item 8. In some embodiments, responsive to determining that data item 9 is not stored locally in local memory, node 1 sends a message indicating data item 9. In some embodiments, node 1 may store data indicating that the data item 9 is stored on node 3 and indicate in the message that the destination is node 3. In other embodiments, node 1 may send the message including an indication of the instructions 1-N, which are the same set of instructions 1 to N already queued for later processing by each of the node 0, node 2 and node 3. In this embodiment, the node 1 may not expect any responses. Responsive to node 3 receiving the message and determining that the data item 9 is stored locally in the local memory, the node 3 may process the set of instructions 1-N using the data item 9.

Alternative to the above, the node 3 may enqueue a task to later process the data item 9. Node 1 is not migrating a thread to node 3 as context information is not sent in the message as it is unnecessary. Rather, node 1 is sending an indication to process the same set of instructions 1-N of which the node 3 is aware and already processing for other data items. For the node 0 and the node 2, responsive to determining that the data item 9 is not locally stored and the message is from another node, such as node 1, rather than the operating system, no further processing may be performed for the received message.

In other embodiments, the node 1 may expect responses from one or more of the other nodes. The responses may include an indication identifying itself, such as a node identifier (ID), and a status of whether or not the identified data item is stored in respective local memory. For example, the response from node 3 may identify the node 3 and indicate that node 3 locally stores the data item 9. The response from node 0 may identify node 0 and indicate that node 0 does not locally store the data item 9. The response from node 2 may identify node 2 and indicate that node 2 does not locally store the data item 9. Responsive to receiving these responses from the other nodes, the node 1 may send a message directly to the node 3 that includes an indication of the data item 9 and an indication of the instructions 1-N, which are the same set of instructions 1 to N already being processed or queued for later processing by each of the node 0, node 2 and node 3.

In some embodiments, the node 1 may receive other information in the response from node 3. Node 3 may send an indication of a distance from node 1 such as a number of hops or other intermediate nodes between node 1 and node 3. Node 3 may also send information indicating a processor utilization value, a local memory utilization value, a power management value, and so forth. Based on the received information, a node may determine which other node may efficiently process the particular instructions using a given data item. Using FIG. 9 as an example, in systems 110-120 each of the nodes has a distance of 1 from one another. However, in system 130 node 11 has a distance of 3 from the node 8. In system 130, each of node 5 and node 6 is used for transferring messages and data between node 4 and node 7. Therefore, if node 8 is relatively idle, whereas the node 11 is experiencing relatively high processor utilization while locally storing a given data item, it may be determined more beneficial to keep the given data item stored on M11 for processing of instructions by the processor P11 rather than transfer the given data item from node 11 to node 8. Generally speaking, any suitable combination of parameters with relative weights or priorities may be used for determining which node causes the smallest cost for the system when selected for processing the instructions using a given data item determined to not be locally stored for a processor initially assigned to process the instructions.

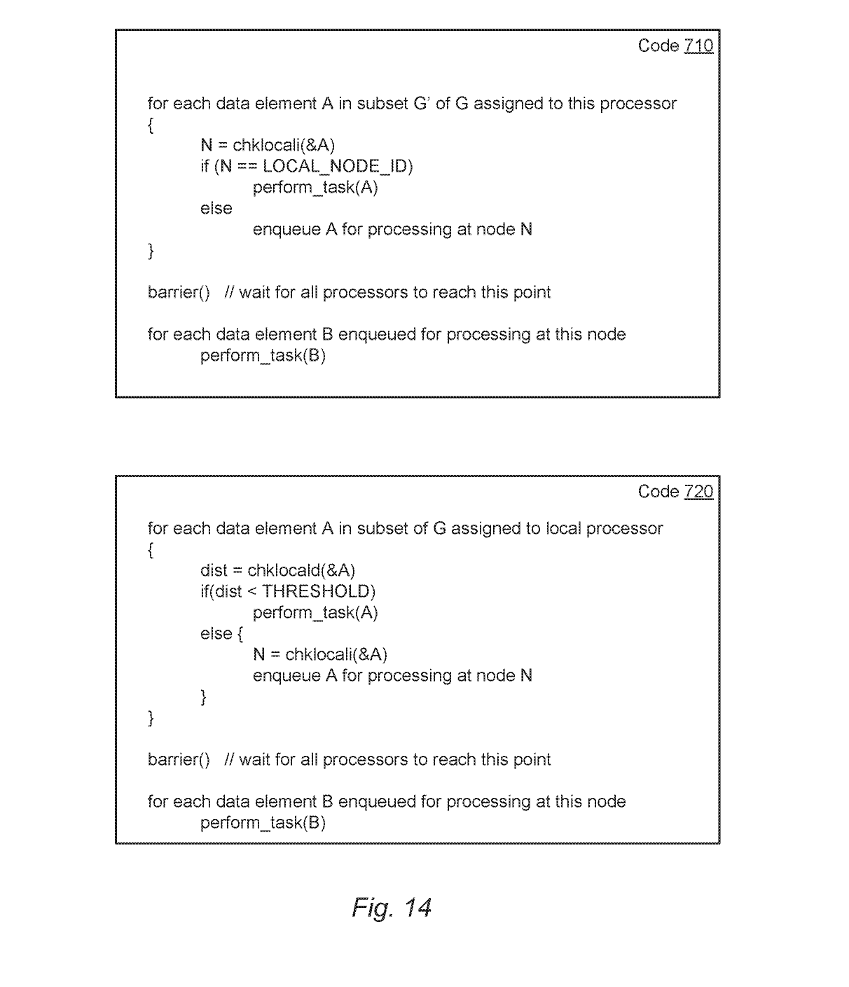

Referring now to FIG. 14, one embodiment of code 710 including an instruction to identify the location of a given data item and to process the given item among multiple nodes is shown. In the example shown in code 710, the instruction chklocali( ) may return an indication of a node, such as a unique node identifier (ID), that locally stores the requested data item. Similar to the earlier chklocal( ) instruction in code 400, in various embodiments, the chklocali( ) instruction in code 710 uses as an input argument an indication of a virtual address. The chklocali( ) instruction returns the indication of a node, such as a node ID, of the node that locally stores the data item associated with the virtual address.

Using the system 110 as an example, when executing the chklocali( ) instruction in the code 710, each of the nodes 0-3 may translate the input virtual address “A” to a physical address. The physical address may be used to determine whether the physical address is found in the local memory. The methods previously described for this determination may be used. For example, a lookup operation may be performed in the memory controller of the DRAM directly connected to the one or more processors of the node. Alternatively, a lookup is performed in system information structures that store topology information for all the processors and memory. Two examples of such structures include the System Resource Affinity Table and the System Locality Distance Information Table.

When the above determination completes, a state machine or other control logic may return the indication of whether the address is associated with a data item stored in the local memory. In the case of a “hit”, where the address is determined to be associated with a data item stored in the local memory, the data item is not retrieved from the local memory. Rather the indication identifying the node may be returned. For example, when node 1 processes the chklocali( ) instruction for the data item 7, the indication identifying the node 1 is returned. In the case of a “miss”, where the physical address is determined to be associated with a data item not stored in the local memory, no access request is generated to retrieve the data item from a remote memory. When node 1 processes the chklocali( ) instruction for the data item 12, no access request is generated to retrieve the data item 12 from a remote memory. Rather, the node 1 sends query messages to the node 0, the node 2 and the node 3 to determine which node locally stores the data item 12. The node 0 will return a response indicating it locally stores the data item 12 and the response also includes an indication identifying the node 0, such as a node ID 0. Continuing with the code 710, the node 1 sends a message to node 0 to process the set of instructions 1-N using the data item 12. A checkpoint is also used in code 710 (i.e., the “barrier” instruction) following the for loop to enable synchronization as discussed above.

A further example is the chklocald( ) instruction in the code 720. This variant of the earlier instruction uses an indication of a virtual address as an input argument, but it returns a distance value indicating how far away the requested data item is from the node. If the requested data item is stored locally, in some embodiments, the distance value returned is 0. When the requested data item is stored remotely on another node, the distance value may be a non-zero value corresponding to a number of hops traversed over a network or a number of nodes serially connected between the node storing the requested data item and the node processing the chklocald( ) instruction for the requested data item.

In some embodiments, the distance value may be part of a cost value that may also include one or more of the processor utilization of the remote node, the memory utilization of the remote node, the size of the data item, and so forth. The distance value alone or a combined cost value may be used to determine whether to move the data item from the remote node where it is locally stored. If the threshold of the distance value or the cost value for moving the data item is above a threshold, then the data item may remain where it is stored locally at the remote node and the remote node receives a message to process the set of instructions on the data item as described earlier.

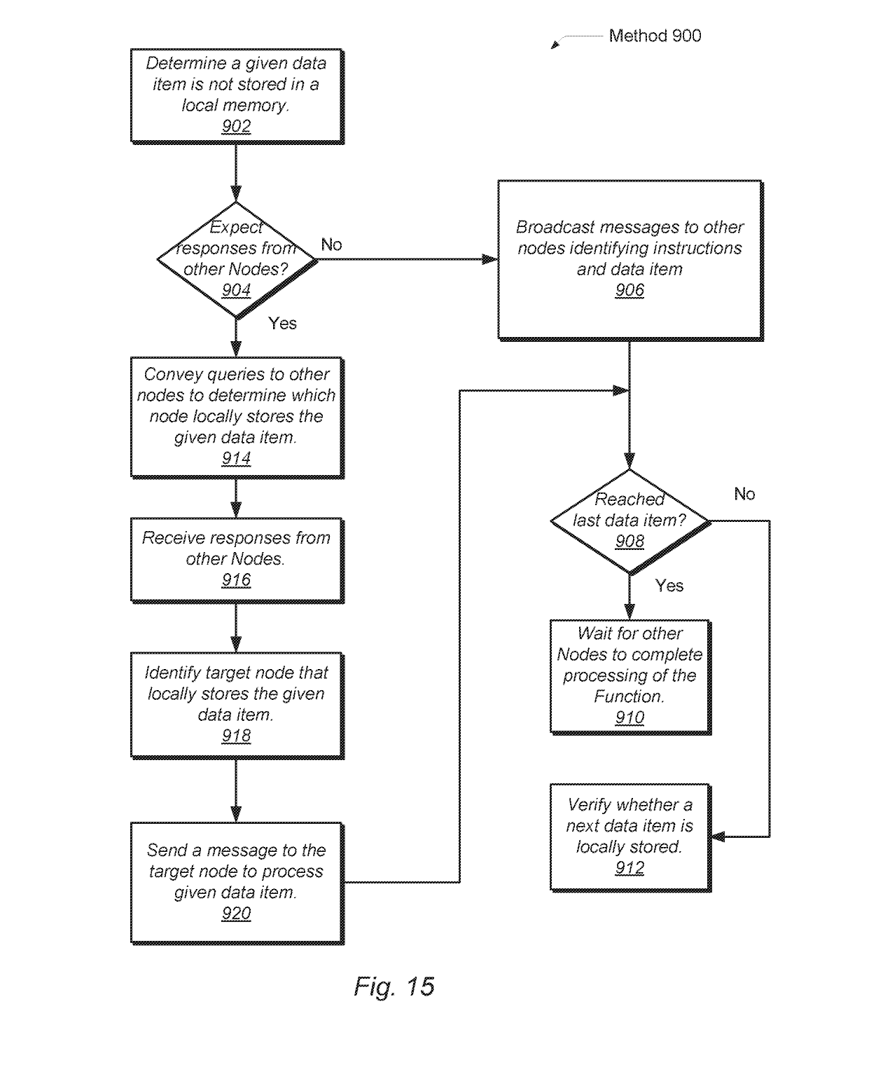

Turning now to FIG. 15, another embodiment of a method 900 for efficiently locating data in a computing system is shown. As described earlier, one or more data items are assigned to a set of one or more instructions. The set of one or more instructions is scheduled to be processed on each node of multiple nodes of a NUMA system. For each node of the multiple nodes in the system, a data item is identified to process. Each of the nodes may perform a check to verify whether a given data item is stored in its local memory. In block 902, a given data item is determined not to be stored in a local memory of a given node. Alternative processing is performed for the given data item rather than processing of the set of instructions for the given data item. As described further below, the alternative processing includes sending messages to other nodes, where each message includes an indication of the given data item, an indication of the set of instructions, and an indication to process the set of instructions with the given data item responsive to determining the given data item is locally stored in the other node.

If responses are not expected from other nodes for a broadcast used for determining which node does locally store the given data item (conditional block 904), then in block 906, the given node prepares messages to broadcast to the other nodes that do not depend on responses. Each message may indicate the given data item, the set of instructions that each node is currently processing or has queued for processing to accomplish a group task, an indication to check whether the given data item is locally stored and an indication to process the set of instructions using the given data item if the given data item is determined to be locally stored. The given node sends this message to each of the other nodes in the system.

If the last data item is reached (conditional block 908), then in block 910, in some embodiments, the given node waits for the other nodes in the system to complete processing of the set of instructions which may be part of a function or otherwise. For example, a checkpoint may be used. Otherwise, in block 912, the given node may move on to a next data item and verify whether the next data item is locally stored.

If responses are expected from other nodes for a broadcast used for determining which node does locally store the given data item (conditional block 904), then in block 914, the given node broadcasts queries to the other nodes to determine which node in the system locally stores the given data item. The query may include at least an indication of the given data item and a request to return an indication of whether the given data item is locally stored and an indication identifying the responding node. In some embodiments, only the node that locally stores the given data item is instructed to respond. In other embodiments, each node receiving the query is instructed to respond.

In block 916, the given node receives one or more responses for the queries. In block 918, using the information in the received responses, the given node identifies the target node that locally stores the given data item. In some embodiments, the responses include cost values and a distance value as described earlier. The given node may use the cost value and/or the distance value to determine on which node to process the set of instructions using the given data item. If the given node does not use the cost value or the distance value, then the target node is the node that locally stores the given data item. Additionally, the given node may use the cost value and/or the distance value and still determine that the target node is the node that locally stores the given data item. In block 920, the given node sends a message to the target node that indicates the given data item, the set of instructions that each node is currently processing or has queued for processing to accomplish a group task, and an indication to process the set of instructions using the given data item.

It is noted that the above-described embodiments may include software. In such an embodiment, the program instructions that implement the methods and/or mechanisms may be conveyed or stored on a non-transitory computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, or Blu-Ray. Storage media may further include volatile or non-volatile memory media such as RAM (e.g. synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. Storage media may include microelectromechanical systems (MEMS), as well as storage media accessible via a communication medium such as a network and/or a wireless link.

Additionally, program instructions may include behavioral-level description or register-transfer level (RTL) descriptions of the hardware functionality in a high level programming language such as C, or a design language (HDL) such as Verilog, VHDL, or database format such as GDS II stream format (GDSII). In some cases the description may be read by a synthesis tool, which may synthesize the description to produce a netlist comprising a list of gates from a synthesis library. The netlist includes a set of gates, which also represent the functionality of the hardware comprising the system. The netlist may then be placed and routed to produce a data set describing geometric shapes to be applied to masks. The masks may then be used in various semiconductor fabrication steps to produce a semiconductor circuit or circuits corresponding to the system. Alternatively, the instructions on the computer accessible storage medium may be the netlist (with or without the synthesis library) or the data set, as desired. Additionally, the instructions may be utilized for purposes of emulation by a hardware based type emulator from such vendors as Cadence®, EVE®, and Mentor Graphics®.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
a processing unit executing an instruction, the instruction identifying an address corresponding to a data location;
determining whether a memory device stores data corresponding to the address; and
returning a response that indicates whether the memory device stores data corresponding to the address, wherein processing of the instruction is completed without retrieving the data.

2. The method as recited in claim 1, wherein the response is a Boolean value.

3. The method as recited in claim 1, wherein the processing unit and memory device are part of a distributed memory computing system, and wherein the memory device is deemed local to the processing unit.

4. The method as recited in claim 1, further comprising accessing a table to determine whether the address is mapped to the memory device.

5. The method as recited in claim 1, wherein the memory device corresponds to one of a plurality of memory devices in a distributed memory computing system.

6. The method as recited in claim 1, wherein the response comprises an identifier of a given processing unit, wherein a memory device deemed local to the given processing unit stores data corresponding to the address.

7. The method as recited in claim 6, wherein the given processing unit is the same as the processing unit executing the instruction.

8. The method as recited in claim 6, wherein the given processing unit is different from the processing unit executing the instruction.

9. The method as recited in claim 1, wherein the response comprises a distance between a given processing unit and the processing unit executing the instruction, wherein a memory device deemed local to the given processing unit stores data corresponding to the address.

10. A computing system comprising:
a processing unit; and
a memory device;
wherein the processing unit is configured to:
execute an instruction, the instruction identifying an address corresponding to a data location;
determine whether a memory device stores data corresponding to the address; and
return a response that indicates whether the memory device stores data corresponding to the address, wherein processing of the instruction is completed without retrieving the data.

11. The computing system as recited in claim 10, wherein the processing unit and memory device are part of a distributed memory computing system, and wherein the memory device is deemed local to the processing unit.

12. The computing system as recited in claim 10, wherein the memory device corresponds to one of a plurality of memory devices in a distributed memory computing system.

13. The computing system as recited in claim 10, wherein the response comprises an identifier of a given processing unit, wherein a memory device deemed local to the given processing unit stores data corresponding to the address.

14. The computing system as recited in claim 13, wherein the given processing unit is different from the processing unit executing the instruction.

15. The computing system as recited in claim 10, wherein the response comprises a distance between a given processing unit and the processing unit executing the instruction, wherein a memory device deemed local to the given processing unit stores data corresponding to the address.

16. The computing system as recited in claim 10, wherein the response includes a cache coherence state of the data object.

17. A non-transitory computer readable storage medium storing program instructions, wherein the program instructions are executable by a processor to:
execute an instruction in a processing unit, the instruction identifying an address corresponding to a data location;
determine whether a memory device stores data corresponding to the address; and
return a response that indicates whether the memory device stores data corresponding to the address, wherein processing of the instruction is completed without retrieving the data.

18. The non-transitory computer readable storage medium as recited in claim 17, wherein the response is an identifier of a given processing unit, wherein a memory device deemed local to the given processing unit stores data corresponding to the address.

19. The non-transitory computer readable storage medium as recited in claim 18, wherein the given processing unit is different from the processing unit executing the instruction.

20. The non-transitory computer readable storage medium as recited in claim 17, wherein the response comprises a distance between a given processing unit and the processing unit executing the instruction, wherein a memory device deemed local to the given processing unit stores data corresponding to the address.
